(19) United States
(12) Patent Application Publication
(10) Pub. No.: US 2024/0020641 A1
(43) Pub. Date: Jan. 18, 2024

(54) DOMAIN DRIVEN SECURE DESIGN OF DISTRIBUTED COMPUTING SYSTEMS

(71) Applicant: Kyndryl, Inc., New York, NY (US)

(72) Inventors: Zbigniew Jan BOROWSKI, Cobb, GA (US); Xavier Gonzalo SANTOLARIA, Begnins (CH); Gerald Matthew COMEAU, Spring Hill, FL (US); Michael J SPISAK, East Northport, NY (US)

(21) Appl. No.: 17/865,570

(22) Filed: Jul. 15, 2022

(51) Int. Cl. G06Q 10/08; G06Q 30/02

(52) U.S. Cl. CPC G06Q 10/0875; G06Q 30/0282

(57) ABSTRACT

A computer-implemented method, including identifying distributed computing design requirements; determining system offerings based on a machine learning model trained with the distributed computing design requirements; providing the system offerings for selection by a customer; receiving selections of the system offerings; and generating a bill of materials based on the selections of the system offerings.

### BACKGROUND

Aspects of the present invention relate generally to cloud computing system design and, more particularly, to domain driven secure design of cloud computing systems.

Cloud computing systems come in many packages. Introduction of cloud services comes with its own complexities and challenges due to computing services existing off-premises to a business. This introduction of entities that are non-centralized and indirectly controlled by the business in off-premises environments requires further consideration of responsibilities of the business and security of cloud computing system data used by the business. Cloud catalogs with offerings for each package are relatively static. Users/customers may have different requirements for different applications of the cloud computing system. These cloud computing systems are provided to clients as a cloud solution to their requirements. Additionally, each cloud computing system provider has many different offerings for cloud computing system designs. Cloud engineering utilizes cloud computing resources to address specific business issues. Cloud engineering leverages methods and tolls in architecting, designing, developing, operating and maintaining the cloud computing systems.

### SUMMARY

In a first aspect of the invention, there is a computer-implemented method including: identifying, by a computing device, distributed computing design requirements; determining, by the computing device, system offerings based on a machine learning model trained with the distributed computing design requirements; providing, by the computing device, the system offerings; collecting, by the computing device, selections of the system offerings; and generating, by the computing device, a bill of materials based on the selections of the system offerings.

In another aspect of the invention, there is a computer program product including one or more computer readable storage media having program instructions collectively stored on the one or more computer readable storage media. The program instructions are executable to: identify distributed computing design requirements; identify a solution pattern matching the distributed computing design requirements based on a machine learning model trained with a customer profile and the distributed computing design requirements; determine system offerings based on the matched solution pattern; provide the system offerings to customers for selection; collect selections of the system offerings; and generate a bill of materials based on the selections of the system offerings.

In another aspect of the invention, there is system including a processor, a computer readable memory, one or more computer readable storage media, and program instructions collectively stored on the one or more computer readable storage media. The program instructions are executable to: identify distributed computing design requirements; determine system offerings utilizing a machine learning model trained with the distributed computing design requirements; mapping a security control or system feature to the system offerings; provide the system offerings to customers for selection through a solution blueprint; collect selections of the system offerings from responses to the solution blueprint; updating a solutioning database with the selections of the system offerings; and generate a bill of materials based on the selections of the system offerings.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows a flowchart of another exemplary method in accordance with aspects of the present invention.

FIG. 7 shows a diagram of a solution blueprint in accordance with aspects of the present invention.

FIGS. 8A and 8B show diagrams of a solution blueprint of system offerings (FIG. 8A) and additional information provided for each system offering (FIG. 8B) for a governance, risk, and compliance domain in accordance with aspects of the present invention.

FIGS. 9A and 9B show diagrams of a solution blueprint of system offerings (FIG. 9A) and additional information provided for each system offering (FIG. 9B) for an application/container security domain in accordance with aspects of the present invention.

FIGS. 10A, 10B, and 10C show diagrams of a solution blueprint of system offerings (FIG. 10A), additional information provided for each system offering (FIG. 10B), and a decision tree (FIG. 10C) for an infrastructure and endpoint protection domain in accordance with aspects of the present invention.

FIGS. 11A and 11B show a diagram of a solution blueprint of system offerings (FIG. 11A) and additional information provided for each system offering (FIG. 11B) for a threat detection and response domain in accordance with aspects of the present invention.

FIGS. 12A and 12B show diagrams of a solution blueprint of system offerings (FIG. 12A) and additional information provided for each system offering (FIG. 12B) for resiliency—disaster recovery domain in accordance with aspects of the present invention.

### DETAILED DESCRIPTION

Aspects of the present invention relate generally to cloud computing system design and, more particularly, to domain driven secure design of cloud computing systems. In embodiments, a computing device facilitates cloud computing system design using a domain driven secure cloud design approach relating customer profiles and requirements with cloud solutions. In this manner, implementations of the invention provide a systemic process relying upon domain driven secure design to determine the best available product meeting all of a customer's requirements.

In aspects of the invention, there is a computer-implemented method including: recognizing a set of desired functions for a target cloud computing system; identifying a set of domain-related requirements associated with the desired functions; determining, by the computer, solution components appropriate to provide the desired functions in a manner that satisfies the requirements; and generating a Bill of Materials that identifies the solution components. The recognizing includes using an artificial intelligence (AI) model trained to extract operational requirements from a provided specification (e.g., a secure cloud engineering blueprint, etc.). The identifying is accomplished by an AI model trained to recognize domain-specific security thresholds associated with the requirements. The determining is accomplished by an AI model trained to find, from a set of available application components, components suited to accomplish the desired functions while meeting the requirements.

Cloud computing system design and solutioning may include selections of various solutions to meet customer needs. In embodiments, the AI model may include computer modeling such as machine learning and/or natural language processing (NLP) models to (i) identify customer profiles that may match or are similar; (ii) recognize/identify customer requirements based on customer profiles; and (iii) identify cloud computing system components that meet the customer requirements. The terms “machine learning”, “machine learning model” and “machine learning processing” may denote methods of enabling a computer system to improve its capabilities automatically through experience and/or repetition without procedural programming. For example, machine learning algorithms build a mathematical model based on sample data, known as “training data”, to make predictions or decisions without being explicitly programmed to do so.

Cloud computing systems are designed with customer requirements in mind, however, something that customers often lack knowledge of and do not consider is security and compliance requirements. Thus, oftentimes, cloud computing systems are designed with security and compliance contemplated only after the initial solutions are generated for the cloud computing system. This results in a back-and-forth design process that takes more time and does not optimize the cloud system for security purposes. In fact, in some instances, security issues may occur after completion of the cloud system due to unforeseen regulations.

Further, there is a lack of a systematic and logical approach to meeting both security and compliance requirements as well as customer needs. Thus, a systematic method is needed to make security and compliance a key consideration when initially beginning the design process, as well as, systematically providing customers with offerings that will meet the additional requirements including those the customer themselves have not considered.

Accordingly, implementations of the invention provide an improvement in the technical field of domain driven secure design of cloud computing systems by providing a technical solution to the above known problems of cloud computing system design. For example, in embodiments, the technical solution may include, amongst other features: identifying distributed computing design requirements; determining system offerings based on a machine learning model trained with the distributed computing design requirements; providing the system offerings; collecting selections of the system offerings; and generating a bill of materials based on the selections of the system offerings. The technical solution may also use a solution blueprint that is security domain driven to systematically step through offerings that meet the customer cloud computing system design with an emphasis on security. These steps allow the cloud computing system design to provide a security centric solutioning for customer requirements. Further, these steps allow the domain driven secure design of cloud computing systems to more efficiently and effectively provide customers with the cloud computing products that they need while placing a strong importance on the security of their cloud computing system.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

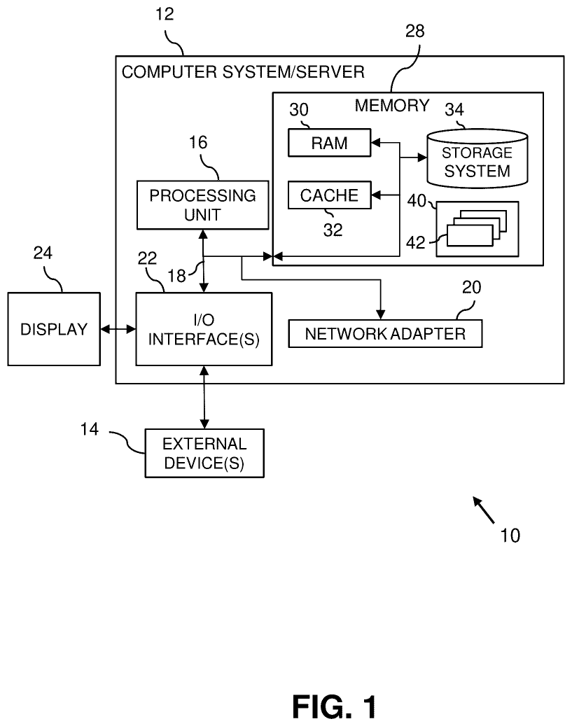

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

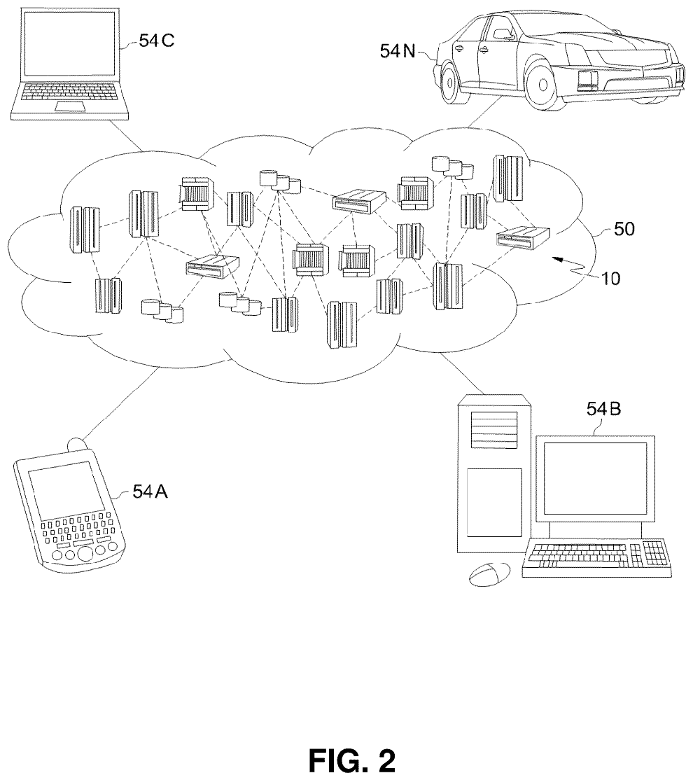

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

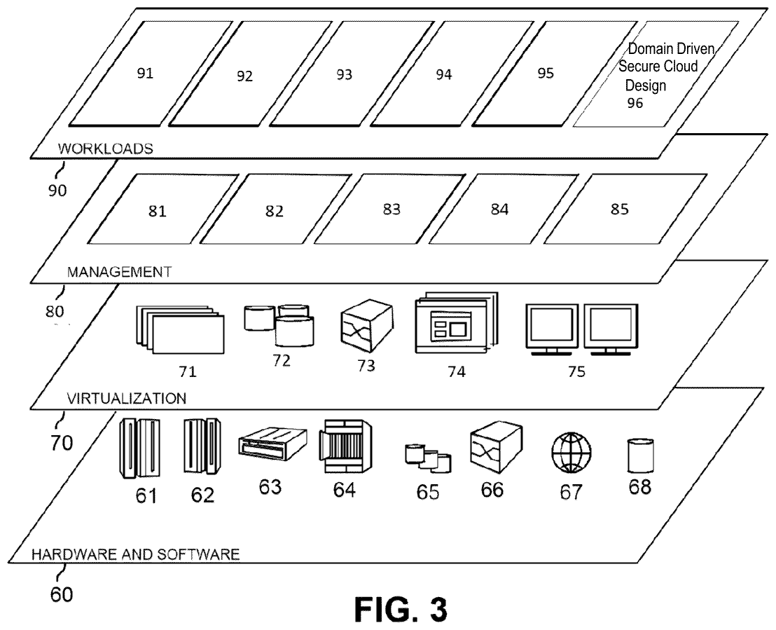

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and domain driven secure cloud design 96.

Implementations of the invention may include a computer system/server 12 of FIG. 1 in which one or more of the program modules 42 are configured to perform (or cause the computer system/server 12 to perform) one of more functions of the domain driven secure cloud design 96 of FIG. 3. For example, the one or more of the program modules 42 may be configured to: identify cloud design requirements; determine system offerings based on the cloud design requirements; and provide the system offerings to customers for selection; collect selections of the system offerings; and generate a bill of materials based on the selections of the system offerings.

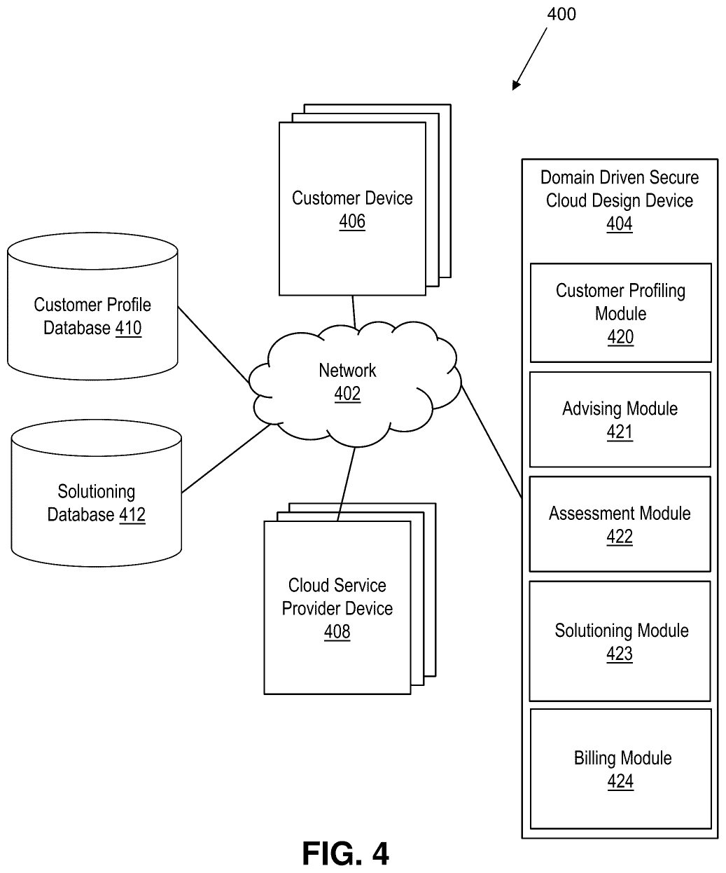

FIG. 4 shows a block diagram of an exemplary environment in accordance with aspects of the invention. In embodiments, the domain driven secure cloud design environment 400 includes a network 402 enabling communication between domain driven secure cloud design device 404, customer device 406, cloud service provider device 408, customer profile database 410, and solutioning database 412.

In embodiments, the customer device 406 comprises a computing device (e.g., the computer system/server 12 of FIG. 1, or elements thereof) in a networked environment. In implementations, the customer device 406 comprises a personal computing device (e.g., 54A, 54B, 54C, etc.) in the cloud computing environment 50 of FIG. 2. The customer device 406 may comprise one or more program modules such as program modules 42 described with respect to FIG. 1. In accordance with aspects of the invention described below, the customer device 406 may manage and store customer profiles and requirements for use in designing a cloud computing system.

In embodiments, the cloud service provider device 408 comprises a computing device (e.g., the computer system/server 12 of FIG. 1, or elements thereof) in a networked environment. In implementations, the cloud service provider device 408 comprises a personal computing device (e.g., 54A, 54B, 54C, etc.) in the cloud computing environment 50 of FIG. 2. The cloud service provider device 408 may comprise one or more program modules such as program modules 42 described with respect to FIG. 1. In accordance with aspects of the invention described below, the cloud service provider device 408 may manage and store cloud services as offerings. The cloud service provider device 408 may provide information regarding different offerings, products, and services for the cloud system design. The cloud service provider device 408 may send these offerings to the domain driven secure cloud design device 404, or the domain driven secure cloud design device 404 may update the offerings on a schedule for continued maintenance of the offerings.

In implementations, a customer profile database 410 manages and stores information about a customer's profile and cloud design requirements (e.g., distributed computing design requirements). In implementations, the domain driven secure cloud design device 404 may request the customer profile and cloud design requirements from the customer profile database 410. In embodiments, the customer profile database 410 includes a pattern library for customer profiles. The customer profiles in the pattern library may be matched to a customer profile of the requester for the cloud computing system design. In exemplary embodiments, customer profiles in the customer profile database 410 include one or more of the cloud design requirements (e.g., one or more cloud design requirements defined by the customer themselves, as well as, any cloud design requirements already in place); a hardware layer architecture decision (e.g., customer selection of hardware); a selected product (e.g., customer selection of a system offering and/or preference for products); a product selection reasoning (e.g., customer reasoning for selection of the system offering); a pattern modification reasoning (e.g., customer changes to a matched solution pattern based on the customer's cloud design requirements), an industry of the customer, and a location of the customer and cloud system hardware which may be used to determine security regulations and requirements by locality and industry. For example, based on the cloud system hardware location and customer location, different security regulations may be required to be met.

In implementations, a solutioning database 412 manages and stores information about solutions and the customer profile and cloud design requirements. In implementations, the domain driven secure cloud design device 404 may request or access solution patterns and system offerings from the solutioning database 412. In embodiments, the solution patterns may be matched to cloud design requirements accessed from the customer profile database 410 to identify which system offerings are available that meet the customer's needs. In embodiments, the system offerings include all offerings including hardware layer components and cloud system services. In embodiments, if matched to the cloud design requirements, system offerings are then identified based on the matching. In exemplary embodiments, the solution patterns may include one or more of an industry of the system offerings (e.g., health industry may need higher security standards to meet regulations); a solution blueprint (e.g., steps for selecting system offerings by the customer); a component (e.g., a hardware layer component of the cloud computing system); a solutioning product (e.g., a cloud system service); a decision tree (e.g., process to select individual features, controls, and system offerings from the solution blueprint); the bill of materials (i.e., cost for each of the selected system offerings); and a price (e.g., a cost for each system offering).

In embodiments, the domain driven secure cloud design device 404 comprises customer profiling module 420, advising module 421, assessment module 422, solutioning module 423, and billing module 424, each of which may comprise one or more program modules such as program modules 42 described with respect to FIG. 1. The domain driven secure cloud design device 404 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the customer profiling module 420 is configured to manage and collect information about and associated with the customer from the customer profile database 410. In embodiments, the customer profiling module 420 may also manage the information included in the customer profiles including cloud design requirements associated with the customer, hardware layer architecture decisions; a selected product; reasoning for selecting the selected product; and reasoning for pattern modification (if any changes have occurred). In exemplary embodiments, this customer profile information may be used for analysis to determine or identify cloud design requirements for a customer.

In embodiments, the advising module 421 is configured to determine or identify system offerings based on cloud design requirements. In embodiments, the advising module 421 accesses and compares customer profiles for matches to better determine cloud design requirements. In exemplary embodiments, a customer profile is matched to another customer profile to determine similarities utilizing a machine learning model trained with the information from the customer profile described above and resulting cloud design requirements. In exemplary embodiments, the machine learning model may include a collaborative filtering machine learning model to identify relationships between the information in the customer profile. In other words, the machine learning model compares and weighs different information from a customer profile to information in another customer profile. For example, information associated with the industry of a customer may be weighted more heavily because the industry may have a large effect on the cloud design requirements (e.g., in the instance of health industry customers requiring greater privacy and security concerns than a software application customer). Thus, in this example, customer profiles in the same industry will more likely be matched to the instant customer profile. In embodiments, if matched, the matched customer profile may provide cloud design requirements that are likely applicable to the instant customer profile in question.

In embodiments, the assessment module 422 is configured to determine or identify system offerings and recommendations based on cloud design requirements. The cloud design requirements may be determined to match a solution pattern thus providing the customer with pre-established system offerings that may meet their needs. In embodiments, the assessment module 422 accesses and compares the cloud design requirements from the customer profile database 410 to solution patterns and system offerings from the solutioning database 412. In embodiments, the assessment module 422 may collect/receive system offerings and information about the system offerings from service providers and may store these system offerings in a knowledge base. The assessment module 422 may regularly update the knowledge base by trawling the service providers for updated and new information about system offerings. In exemplary embodiments, the service providers directly send updated and new information about system offerings to the assessment module 422.

In embodiments, the assessment module 422 analyzes whether a feature or control is applicable from the security solution blueprint in association with the cloud design requirements. For example, optional features/controls may be removed based on customer interest in reducing costs. In embodiments, the assessment module 422 also analyzes whether the system offerings meet the needs of the customer indicated by the cloud design requirements of the solution pattern. The assessment module 422 may provide recommendations utilizing a machine learning model trained with information from the solution pattern information described above and associated cloud design requirements to determine recommended system offerings.

In embodiments, the assessment module 422 identifies and determines the features and controls and subsequently the system offerings, by analyzing and reviewing the scope and the cloud design requirements themselves. For example, a cloud design requirement may include the need to allow access from individuals worldwide but also with highly sensitive information. The scope of such a cloud design requirement may include features and controls tied to storage as well as data loss prevention, among others. System offerings for this cloud design requirement may include more secure access requirements for individuals and greater decentralization of information.

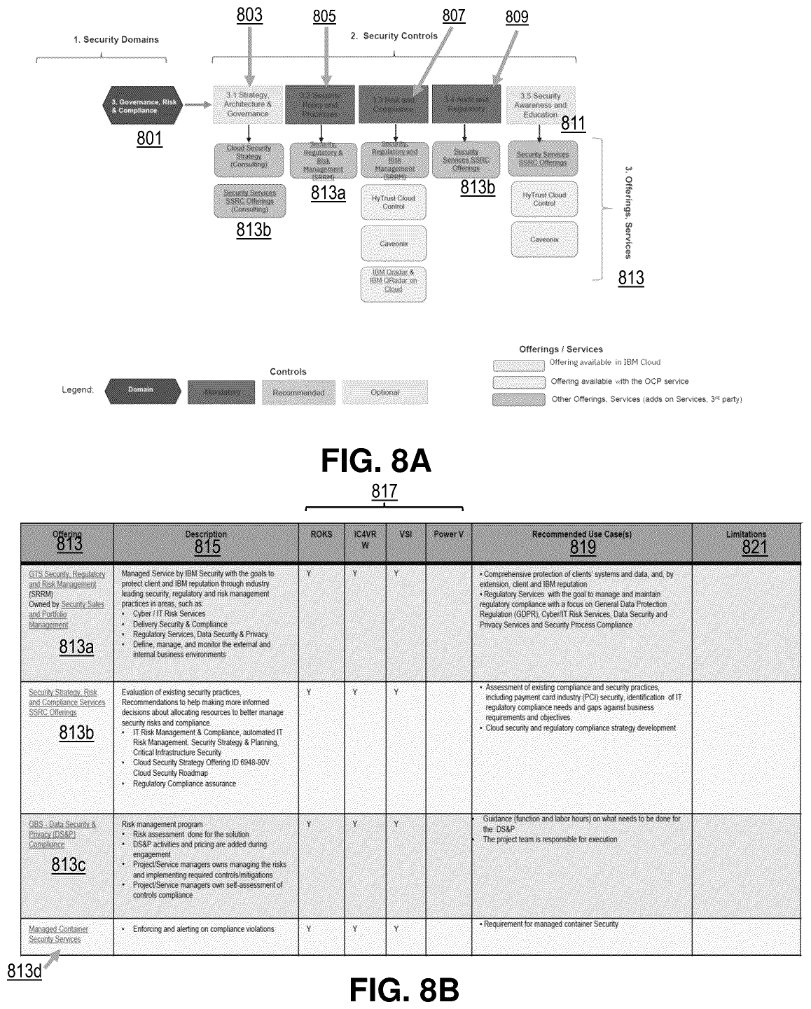

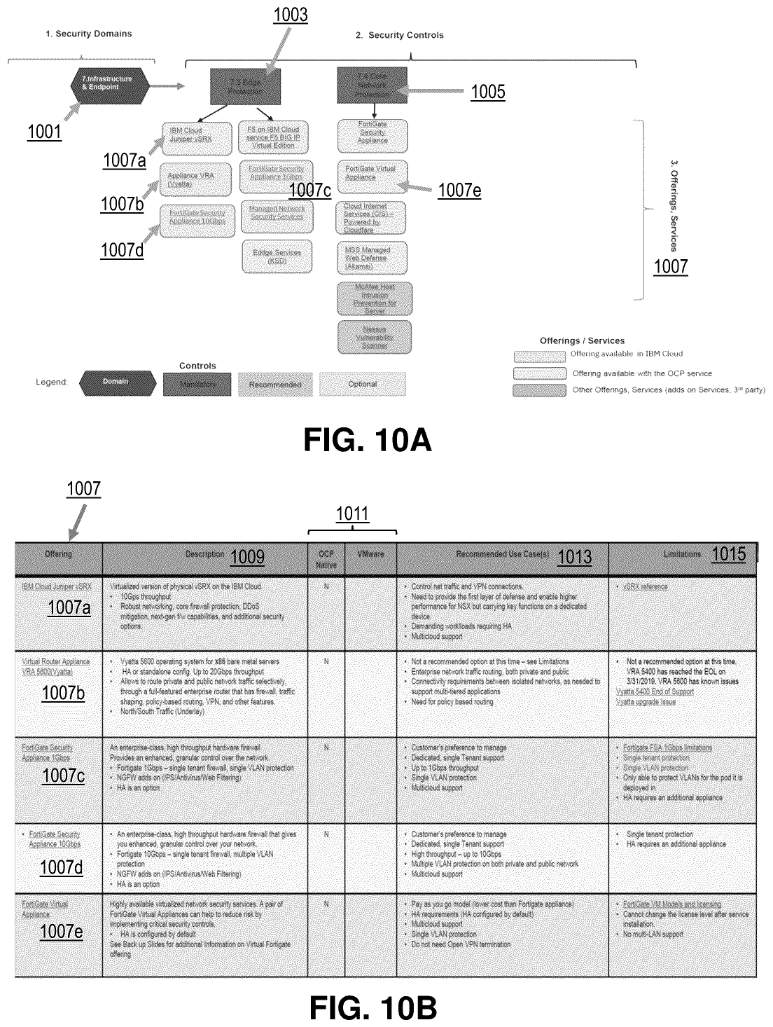

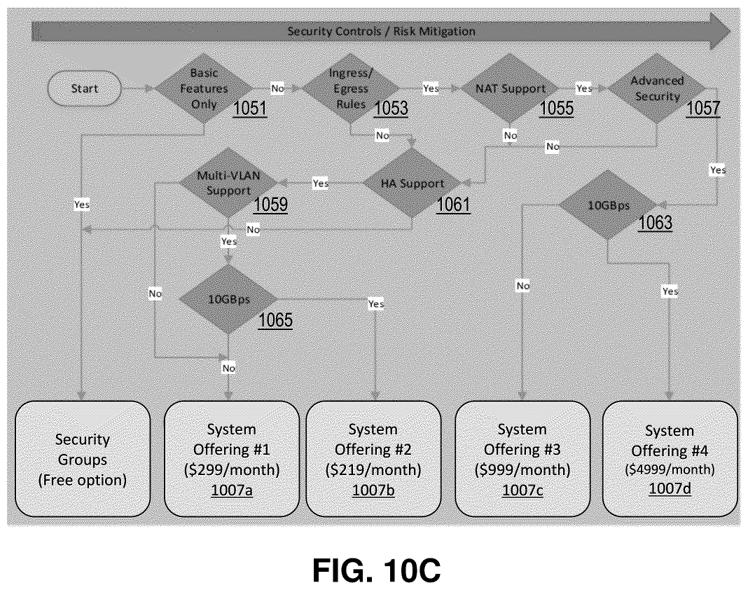

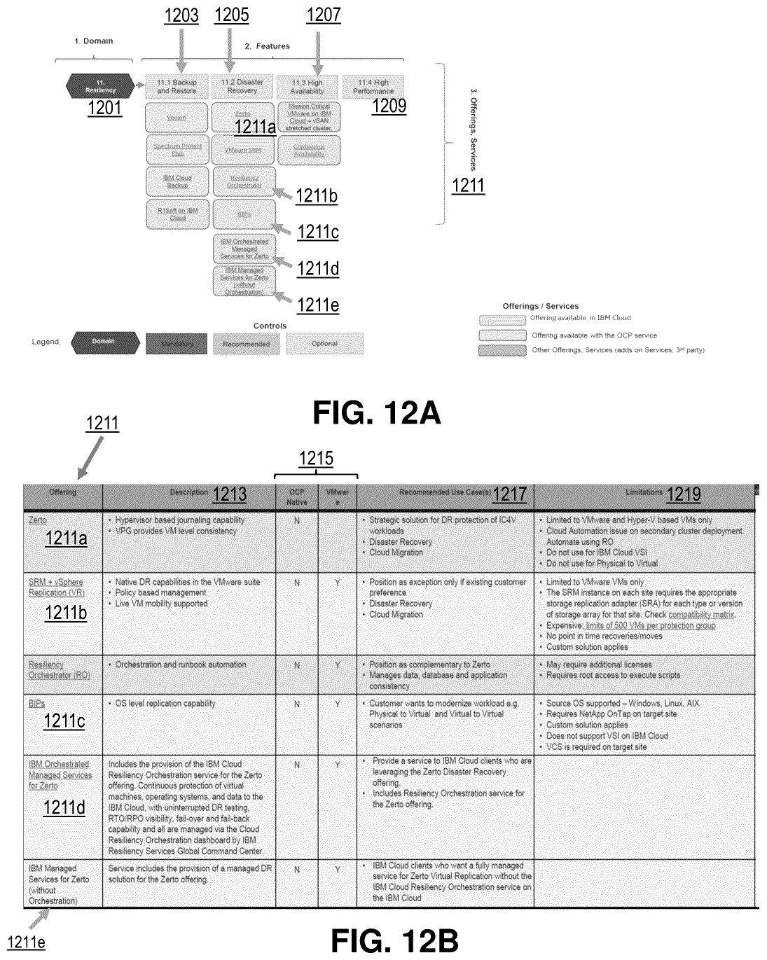

In embodiments, these system offerings are provided to the user/customer to view through the blueprint. The customer may then select from the system offerings in the blueprint and/or step through questions from a blueprint decision tree (see, e.g., FIGS. 10C and 12C) to select the system offering that best suites the customer's needs. Non-limiting examples of these blueprints are presented in FIGS. 8-12. In exemplary embodiments, the machine learning model includes a regression model to determine relationships between the information from the solution patterns with the system offerings. For example, the information from the solution patterns may be weighted and indicate one or more system offerings should be provided to a customer for selection. It is contemplated that some system offerings will not be able to be used with particular selections and the blueprint can and will change based on selected offerings. For example, if a customer selects a specific hardware architecture that is incapable of use with a system offering, the system offering is removed from the blueprint to reduce confusion for the customer.

In embodiments, the solutioning module 423 is configured to determine or identify the system offerings and provide recommendations. In embodiments, the system offerings are determined from the cloud design requirements. In other embodiments, the system offerings are identified from a matched solution pattern. In embodiments, the customer profile may also be utilized in indicating preference for particular system offerings. In embodiments, the solutioning module 423 matches cloud design requirements to the solution patterns. In exemplary embodiments, this matching may determine similarities utilizing a machine learning model trained with the information from the solution pattern information described above and associated cloud design requirements. Similar to the machine learning model of the advising module 421, the machine learning model of the solutioning module 423 may utilize a collaborative filtering to determine these similarities to the solution patterns. This provides the domain driven secure cloud design device 404 with the most similar solution pattern to the customer's cloud design requirements.

In embodiments, the machine learning model utilized by the advising module 421, the machine learning model utilized by the assessment module 421, and the machine learning model utilized by the solutioning module 423, are the same. In other words, the machine learning model is capable of determining matching customer profiles and cloud design requirements with system offerings. In other embodiments, the machine learning models are different models as described above. In other embodiments, two of the machine learning models are the same and one is different as described above. When a customer makes changes to a solution pattern the information in the solutioning database 412 is updated. In embodiments, the advising module 421 may collect selections by a user of hardware layer selections and/or cloud services.

In embodiments, the billing module 424 is configured to generate a bill of materials for selected system offerings. The bill of materials may include hardware layer selections as well as cloud services included in a domain driven secure cloud design provided to the user by including each selection collected by the advising module 421.

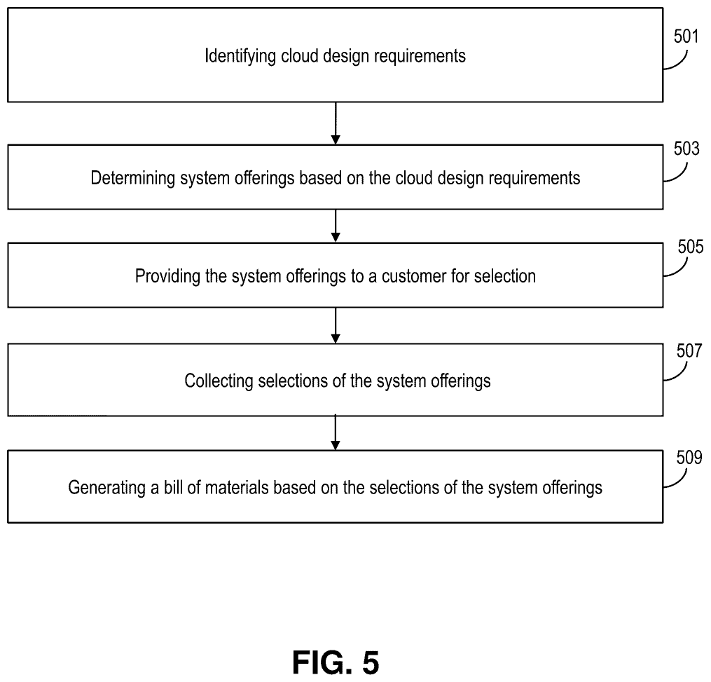

FIG. 5 shows a flowchart of an exemplary method in accordance with aspects of the present invention. Steps of the method may be carried out in the environment of FIG. 4 and are described with reference to elements depicted in FIG. 4.

At step 501, the domain driven secure cloud design device 404 of FIG. 4 identifies cloud design requirements for a customer.

At step 503, the domain driven secure cloud design device 404 of FIG. 4 determines system offerings based on the cloud design requirements.

At step 505, the domain driven secure cloud design device 404 of FIG. 4 provides the system offerings to the customer for selection. In embodiments, the system offerings are received from service provider and are stored with information about the system offerings in a knowledge base stored in the solutioning database 412 to be presented to the customer.

At step 507, the domain driven secure cloud design device 404 of FIG. 4 receives selections of the system offerings from a customer and/or automatically through a machine learning model based on the identified cloud design requirements and/or user preferences. The selection of the system offerings may be optimized using the machine learning model to weight the system offerings in relation to the cloud design requirements met by the system offerings while considering cost for the customer. This optimization may include an optimization of different levels of cost and security. For example, three different cost options could be provided to a customer (low, mid, and high) that meet an associated security level (minimum, medium, and high). For example, a customer may be provided with recommendations of system offerings that are the lowest cost and at a minimum security requirement, a medium cost with medium level of security, and a high cost with high security (e.g., meeting the needs of a customer with an expanding business operation).

At step 509, the domain driven secure cloud design device 404 of FIG. 4 generates a bill of materials based on the selections of the system offerings for presentation to the customer at customer device 406.

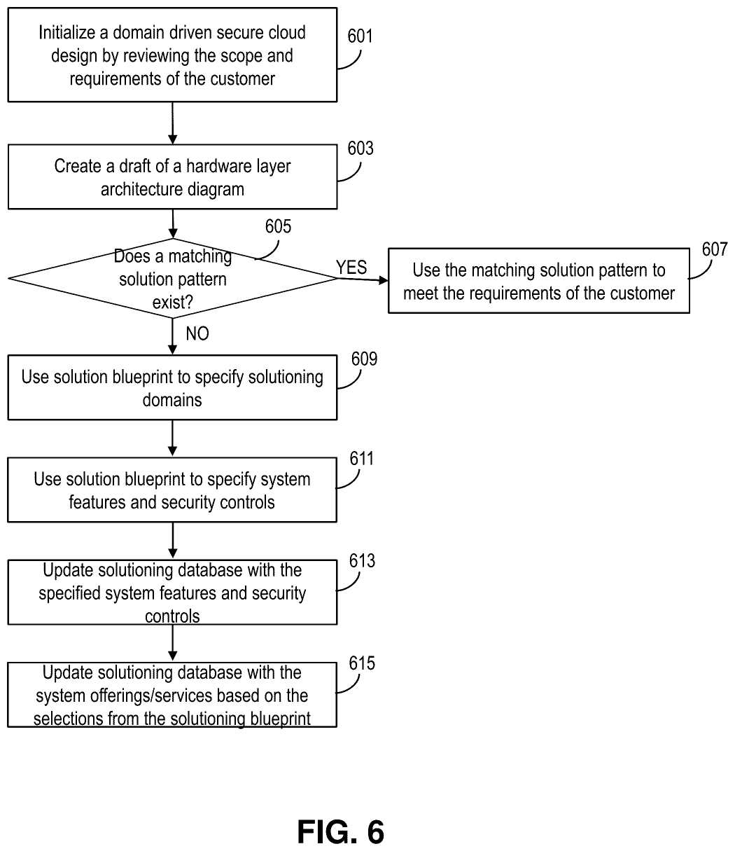

FIG. 6 shows a flowchart of another exemplary method in accordance with aspects of the present invention. Steps of the method may be carried out in the environment of FIG. 4 and are described with reference to elements depicted in FIG. 4.

At step 601, the domain driven secure cloud design device 404 of FIG. 4 initializes a domain driven secure cloud design by reviewing scope and cloud design requirements of a customer. In embodiments, this review of the scope and cloud design requirements for a customer is enacted by the assessment module 422 to identify and determine what features and controls, and subsequently system offerings may meet the needs of the customer.

At step 603, the domain driven secure cloud design device 404 of FIG. 4 creates a draft of a hardware layer architecture diagram. In embodiments, the draft of the hardware layer architecture diagram is determined from the scope and cloud design requirements of the customer. The hardware layer architecture diagram may be broadly established to meet minimum requirements of the customer (e.g., network connection needs, storage needs, etc. including security interests) as well as cloud design requirements that relate to regulations that will have to be met. This draft of a hardware layer architecture may describe the hardware that will be needed, location of the hardware, etc. necessary to implement the cloud system environment.

At step 605, the domain driven secure cloud design device 404 of FIG. 4 determines whether a matching solution pattern already exists. In embodiments, the assessment module 422 is utilized to match cloud design requirements to solution patterns. The solution pattern may include information about a cloud design requirement that is addressed by controls, features, or system offerings and/or customer preferencing/selection of controls, features, or system offerings.

If a solution pattern does exist, at step 607, the domain driven secure cloud design device 404 of FIG. 4 utilizes the matching solution pattern to meet the cloud design requirements of the customer by selecting controls, features, and system offerings and/or providing customers with blueprints with steps to walkthrough to decide/select these controls, features, and system offerings. The matched solution pattern may automatically select particular controls, features, and system offerings or request customer input as well as provide recommendations of particular controls, features, and system offerings that meet the cloud design requirements.

If a solution pattern does not exist, at step 609, the domain driven secure cloud design device 404 of FIG. 4 utilizes solution blueprints to select a solution domain. In embodiments, a machine learning model or customer feedback may be introduced to select the solution domain based on cloud design requirements. The solution domain determines system features and security controls that are applicable and may be assessed to determine whether these selected features and controls meet could meet the needs of the customer prior to selection of system offerings.

At step 611, the domain driven secure cloud design device 404 of FIG. 4 utilizes a solution blueprint to specify/select system features and security controls. The system features are features of a cloud system that are generally optional features not required in the domain driven secure cloud design. The security controls are controls of a cloud system that are generally mandatory or recommended options associated with the security protocols of a domain driven secure cloud design.

At step 613, the domain driven secure cloud design device 404 of FIG. 4 updates the solutioning database with the specified system features and security controls.

At step 615, the domain driven secure cloud design device 404 of FIG. 4 updates the solutioning database with the specified system offerings/services.

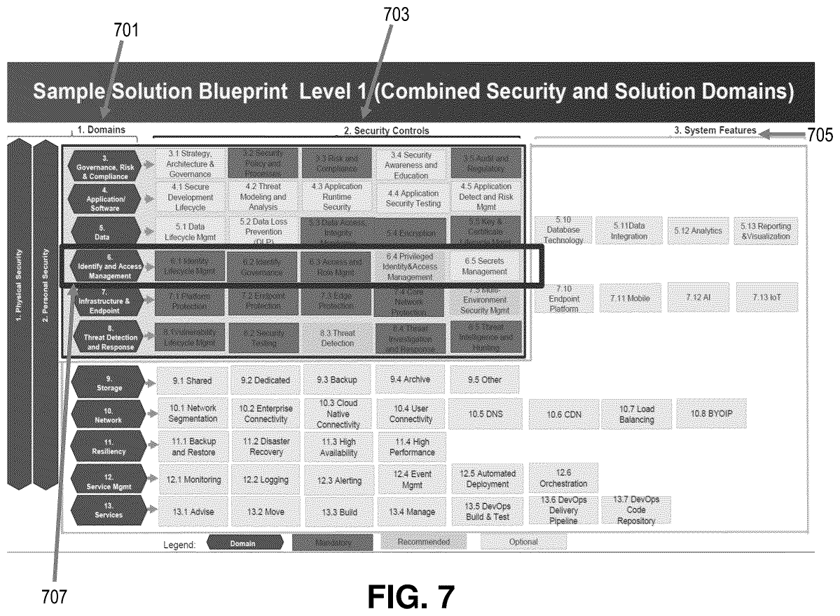

FIG. 7 shows a diagram of a solution blueprint in accordance with aspects of the present invention. The solution blueprint may be provided to customers on customer device 406 in the environment of FIG. 4 and are described with reference to elements depicted in FIG. 4. The solution blueprint of FIG. 7 shows domains 701 from which system features 705 and security controls 703 may be selected. The selected domain 701 will have its own security control 703 and system feature 705 that coincide with the domain 701. In one example, this combination of domain 701 and coinciding security controls 703 is shown by box 707. Although the “identify and access management” domain includes only security controls 703, other domains such as the “data” domain just above the “identify and access management” may include both security controls 703 and system features 705.

In embodiments, the solution blueprint provides a step-by-step process for selecting cloud system offerings. The solution blueprint of FIG. 7 shows only the higher-level domain 701, security control 703, and system feature 705 selections, however, within each of the security controls 703 and system features 705, one or more system offerings may be included as well as information on the system offering and/or a decision tree on how to select from the system offerings that fall under the associated security controls 703 or system features 705. These system offerings are further described in different examples of FIGS. 8-12 below.

FIGS. 8-12 below describe examples of a selection process made for system offerings in a solution blueprint.

In embodiments, step 505 of FIG. 5 may utilize the blueprints of FIGS. 8-12 below to provide features, controls, and system offerings for customer selection. The blueprint may provide the customer with key information and/or a step-by-step decision-making process that results in selection of system offerings that may meet the cloud design requirements of the customer. For example, the customer may walk through each domain and associated controls and features that may be mandatory, recommended, or optional. Each of these controls and features may additionally include one or more system offerings that may further be selected to meet the cloud design requirements of the customer. Similarly, in step 609 of FIG. 6, the same blueprints may be utilized to select domains, features, controls, and system offerings that meet cloud design requirements of the customer.

FIGS. 8A and 8B show diagrams of a solution blueprint of system offerings (FIG. 8A) and additional information provided for each system offering (FIG. 8B) for a “governance, risk, and compliance” domain in accordance with aspects of the present invention. The solution blueprint and system offering information may be provided to customers on customer device 406 in the environment of FIG. 4 and are described with reference to elements depicted in FIG. 4. The “governance, risk, and compliance” domain 801 includes three mandatory security controls (3.2 (805), 3.3 (807), and 3.4 (809)) and two optional security controls (3.1 (803) and 3.5 (811)) with different system offerings for each of these security controls. In embodiments, the system offerings 813 may include offerings that cover multiple security controls such as “security, regulatory & risk management (SRRM)” 813a and “security services SSRC offerings” 813b. FIG. 8B shows a chart with additional information about each system offering (including some that are not shown in FIG. 8A—“GBS—data security & privacy (DS&P) compliance” 813c and “managed container security service” 813d). Each system offering 813 may include additional information such as a description 815, applicable cloud systems 817 with which the system offering may be used, recommended use case(s) 819 for the system offering, and potential limitations 821 to the system offerings. The descriptions 815 may provide additional information about the system offering that may be useful to a customer. The applicable cloud environments/system 817 may indicate whether the system offering can be used by the customer based on general cloud environment, for example, whether the cloud system utilizes virtualization, virtual servers, or uses clustered computing for the customers applications. The recommended use case(s) 819 provide a description of how the system offering could be utilized. The limitations 821 may describe any potential disadvantages or limits to use of the system offering. For example, some system offerings may not easily be scalable to grow with a customer's evolving needs.

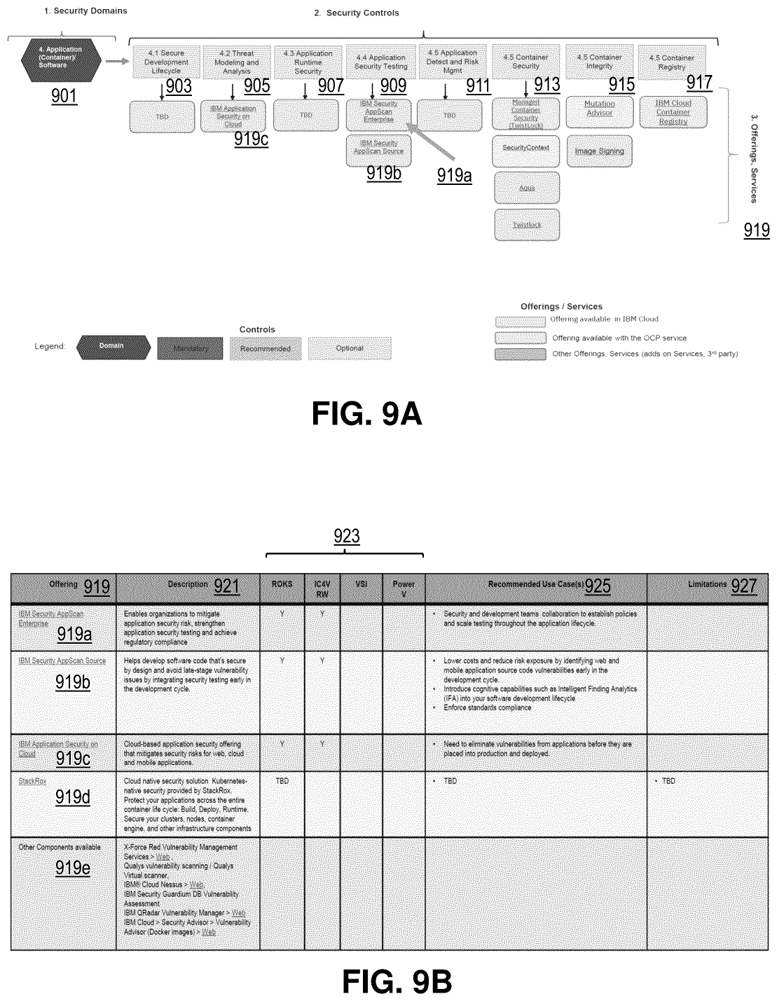

FIGS. 9A and 9B show diagrams of a solution blueprint of system offerings (FIG. 9A) and additional information provided for each system offering (FIG. 9B) for an “application/container security” domain in accordance with aspects of the present invention. The solution blueprint and system offering information may be provided to customers on customer device 406 in the environment of FIG. 4 and are described with reference to elements depicted in FIG. 4. The “application/container security” domain 901 includes optional security controls with optional offerings. In embodiments, the system offerings 919 may include optional security controls 903, 905, 907, 909, 911, 913, 915, and 917. Each of these security controls 903, 905, 907, 909, 911, 913, 915, and 917 may or may not include system offerings including system offerings 919a-919e. For example, the “application security testing” 909 system control may include two system offerings of a “security appscan enterprise” 919a and “security appscan source” 919b. The “threat modeling and analysis” 905 system control may include a system offering of an “application security on cloud” 919c. However, others such as the “application runtime security” 907 control may include a “to be determined” (TBD) indicator showing no system offerings are yet available to directly address this security control. Similar to the additional information for system offerings shown in FIG. 8B, the additional information shown in FIG. 9B includes system offerings 919, descriptions 921, applicable cloud systems 923, recommended use case(s) 925, and limitation 927.

FIGS. 10A, 10B, and 10C show diagrams of a solution blueprint of system offerings (FIG. 10A), additional information provided for each system offering (FIG. 10B), and a decision tree (FIG. 10C) for an “infrastructure and endpoint protection” domain in accordance with aspects of the present invention. The solution blueprint and system offering information may be provided to customers on customer device 406 in the environment of FIG. 4 and are described with reference to elements depicted in FIG. 4. The “infrastructure and endpoint protection” domain includes mandatory security controls with recommended offerings that may be decided with the decision tree of FIG. 10C. The decision tree provides a step-by-step inquiry process to select the system offering that will meet the customer's cloud design requirements. In embodiments, the system offerings 1007 may include system offerings 1007a-1007e. Each of these system offerings 1007 may include additional information shown in FIG. 10B. The additional information may include a description 1009 of the system offerings, applicable control platforms 1011 for the system offerings, recommended use case(s) 1013, and limitations 1015.

The blueprint may also include a decision tree of FIG. 10C with step-by-step inquiries that may be used to guide customers to select a system offering. For example, in FIG. 10C, if only basic features 1051 are needed, then the security groups, or free option is selected. If more than basic features are needed, then the next inquiry asks whether ingress/egress rules 1053 are needed. If yes, then the next inquiry is whether network address translation (NAT) support 1055 is needed. If yes, then whether advanced security 1057 is needed. If yes, then how much bandwidth is needed, such as more or less than 10 GBps 1063. If 10 GBps of bandwidth is needed then offering #4 1007d is selected. If less than 10 GBps is needed then offering #3 is selected. If no to either advanced security 1057 or NAT support 1055, then customer moves to the inquiry of whether high availability (HA) support 1061 is needed. If HA support is not needed, then the original security groups option is selected. If HA support is needed then the inquiry moves to whether multi-VLAN support 1059 is needed. If multi-VLAN support is not needed then offering #1 1007a is selected. If multi-VLAN support is needed, then the question of whether 10 GBps or more of bandwidth is needed 1065. If 10 GBps is needed, then offering #2 1007b is selected. If 10 GBps is not needed, then offering #1 1007a is selected.

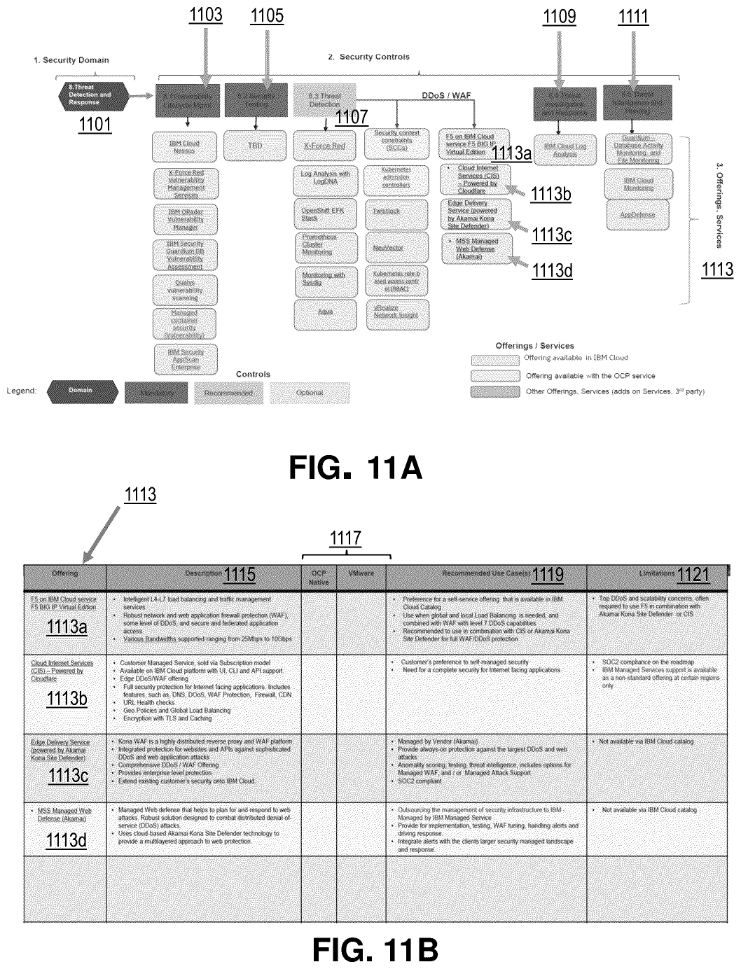

FIGS. 11A and 11B show a diagram of a solution blueprint of system offerings (FIG. 11A) and additional information provided for each system offering (FIG. 11B) for a “threat detection and response” domain in accordance with aspects of the present invention. The solution blueprint and system offering information may be provided to customers on customer device 406 in the environment of FIG. 4 and are described with reference to elements depicted in FIG. 4. The “threat detection and response” domain 1101 includes mostly mandatory security controls with many optional offerings. In embodiments, the system offerings 1113 may include system offerings 1113a-1113d. Each of these system offerings 1113 may include additional information shown in FIG. 11B. The additional information may include a description 1115 of the system offerings, applicable control platforms 1117 for the system offerings, recommended use case(s) 1119, and limitations 1121.

FIGS. 12A and 12B show diagrams of a solution blueprint of system offerings (FIG. 12A) and additional information provided for each system offering (FIG. 12B) for “resiliency—disaster recovery” domain in accordance with aspects of the present invention. The solution blueprint and system offering information may be provided to customers on customer device 406 in the environment of FIG. 4 and are described with reference to elements depicted in FIG. 4. The “disaster recovery” domain 1201 includes only optional system features. In embodiments, the system offerings 1211 may include system offerings 1211a-1211e. Each of these system offerings 1211 may include additional information shown in FIG. 12B. The additional information may include a description 1213 of the system offerings, applicable control platforms 1215 for the system offerings, recommended use case(s) 1217, and limitations 1219.

In embodiments, a service provider could offer to perform the processes described herein. In this case, the service provider can create, maintain, deploy, support, etc., the computer infrastructure that performs the process steps of the invention for one or more customers. These customers may be, for example, a cloud computer system service provider or cloud computer system designer. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a computing device, distributed computing design requirements;
determining, by the computing device, system offerings based on a machine learning model trained with the distributed computing design requirements;
providing, by the computing device, the system offerings for selection;
receiving, by the computing device, selections of the system offerings; and
generating, by the computing device, a bill of materials based on the selections of the system offerings.

2. The computer-implemented method of claim 1, wherein the identifying the distributed computing design requirements includes using a solution blueprint to query a customer for the distributed computing design requirements.

3. The computer-implemented method of claim 1, wherein the identifying the distributed computing design requirements includes:
identifying a customer profile of a customer; and
determining the distributed computing design requirements based on the customer profile.

4. The computer-implemented method of claim 3, wherein the providing the system offerings includes providing a recommendation for the system offerings based on the customer profile and/or distributed computing design requirements.

5. The computer-implemented method of claim 3, further comprising:
matching the customer profile to another customer profile of a pattern library.

6. The computer-implemented method of claim 1, further comprising:
matching the distributed computing design requirements to a solution pattern.

7. The computer-implemented method of claim 6, further comprising:
identifying system offerings based on the matched solution pattern.

8. The computer-implemented method of claim 7, wherein the solution pattern includes one or more selected from the group consisting of:
an industry of the system offerings;
a solution blueprint;
a component;
a solutioning product;
a decision tree;
the bill of materials; and
a price.

9. The computer-implemented method of claim 5, wherein the matching of the customer profile utilizes another machine learning model trained with the customer profile and the distributed computing design requirements.

10. The computer-implemented method of claim 6, wherein the matching of the distributed computing design requirements utilizes another machine learning model trained with the customer profile and the distributed computing design requirements.

11. The computer-implemented method of claim 7, wherein the matching of the customer profile utilizes a machine learning model trained with one or more selected from the group consisting of:
one or more of the distributed computing design requirements;
a hardware layer architecture decision;
a selected product;
a product selection reasoning; and
a pattern modification reasoning.

12. The computer-implemented method of claim 1, wherein the computing device includes software provided as a service in a cloud environment.

13. A computer program product comprising one or more computer readable storage media having program instructions collectively stored on the one or more computer readable storage media, the program instructions executable to:
identify distributed computing design requirements;
identify a solution pattern matching the distributed computing design requirements based on a machine learning model trained with a customer profile and the distributed computing design requirements;
determine system offerings based on the matched solution pattern;
provide the system offerings to customers for selection;
collect selections of the system offerings; and
generate a bill of materials based on the selections of the system offerings.

14. The computer program product of claim 13, wherein the solution pattern includes one or more selected from the group consisting of:
an industry of the system offerings;
a solution blueprint;
a component;
a solutioning product;
a decision tree;
the bill of materials; and
a price.

15. The computer program product of claim 13, wherein the program instructions are further executable to: match the customer profile to another customer profile of a pattern library.

16. The computer program product of claim 15, wherein the matching of the customer profile utilizes another machine learning model trained with the customer profile and the distributed computing design requirements.

17. A system comprising:
a processor, a computer readable memory, one or more computer readable storage media, and program instructions collectively stored on the one or more computer readable storage media, the program instructions executable to:
identify distributed computing design requirements of a customer;
determine system offerings utilizing a machine learning model trained with the distributed computing design requirements;
mapping a security control or system feature to the system offerings;
provide the system offerings to customers for selection through a solution blueprint;
collect selections of the system offerings from responses to the solution blueprint;
updating a solutioning database with the selections of the system offerings; and
generate a bill of materials based on the selections of the system offerings.

18. The system of claim 17, wherein the solution pattern includes one or more selected from the group consisting of:
an industry of the system offerings;
the solution blueprint;
a component;
a solutioning product;
a decision tree;
the bill of materials; and
a price.

19. The system of claim 17, wherein the program instructions are further executable to:
match a customer profile of the customer to another customer profile of a pattern library.

20. The system of claim 19, wherein the matching of the customer profile utilizes another machine learning model trained with the customer profile and the distributed computing design requirements.
